(19) United States
(12) Patent Application Publication
(10) Pub. No.: US 2022/0082725 A1
(43) Pub. Date: Mar. 17, 2022

(54) SENSING CABLE IN A WELLBORE

(71) Applicant: Patriot Research Center, LLC, Houston, TX (US)

(72) Inventors: Brandon Cain, Houston, TX (US); Manish Agarwal, Cypress, TX (US); Michael Pursley, Woodlands, TX (US)

(73) Assignee: Patriot Research Center, LLC, Houston, TX (US)

(21) Appl. No.: 17/033,346

(22) Filed: Sep. 25, 2020

Related U.S. Application Data
(63) Continuation-in-part of application No. 17/019,104, filed on Sep. 11, 2020.

(51) Int. Cl. G01V 11/00; G01V 3/26; G01V 3/28; G01V 1/44; E21B 47/14

(52) U.S. Cl. CPC G01V 11/002; G01V 3/265; E21B 47/14; G01V 1/44; G01V 3/28

(57) ABSTRACT

A sensor system to prevent the unintended severing or damage to a cable or other object within the throughbore of a standpipe or wellhead that may include a blowout preventer and gate valves. Generally, a sensor which may include both an emitter and receiver, is affixed externally to the standpipe, wellhead, blowout preventer, or gate valves. None of the emitter or receiver penetrates the pressure vessel formed by the standpipe, wellhead, blowout preventer, or gate valves. The sensor system may detect disturbances in a pre-existing field such as a geomagnetic sensor detecting the earth's magnetic field, the sensor may create a field and then detect disturbances within that created field such as a magnetic sensor, or the sensor may send a pulse of energy towards the area to be sensed and then read the reflected energy. Generally, the sensor system includes a logic controller, a memory, a sensor or sensors that may or may not include emitters and receivers, and a display. I

### CROSS-REFERENCE TO RELATED APPLICATIONS

This application claims priority to U.S. patent application Ser. No. 17/019,104 that was filed on Sep. 11, 2020.

### BACKGROUND

When drilling and completing an oil and gas well, at the surface is the equipment necessary to contain and control the pressure in downhole formations that may be penetrated by the drilling operation. Generally, a blowout preventer is attached to the uppermost tubular or casing that is cemented within the wellbore. During the completion operations multiple pieces of equipment and/or tubulars are lowered into and raised from the wellbore through the blowout preventer. In many instances other pieces of equipment are attached to the blowout preventer to facilitate moving the equipment into and out of the wellbore during the drilling and completion operations.

For instance, during fracking operations various frac valves may be attached to the blowout preventer along with items such as wireline lubricators. During fracking operations, as each stage is prepared for fracturing, a plug, a setting tool, and a perforating gun are assembled as a unit on the surface and then lowered into the well on a wireline. Once the tools reach the appropriate depth the setting tool sets the plug and then releases the plug. The setting tool and perforating gun are then raised to the appropriate depth where the perforating gun is actuated to form holes in the casing to allow access between the hydrocarbon bearing formation and the interior of the casing. When the perforating gun fires, uncontained pressure may be released into the casing, up the wellbore, and to the surface where the blowout preventer may be closed to contain and control the pressure within the wellbore. In order to perform such an operation, the blowout preventer rams and/or the various valves on the surface must be able to close with sufficient force to shear through most objects that may be within the blowout preventer including various tubulars and certainly the cables and wire that make up wireline. Additionally, the valves must be very fast and easy to close which means that the various surface valves are also easy to accidentally close. Even in the event where the valves are not accidentally closed, the valves may be closed when there are objects within the blowout preventer and other valves that may be unknown to the operator. In any event, if the surface valves are closed, most items within the surface valve's throughbore, will be sheared allowing the items or cable that remain within the well to fall towards the bottom of the well. Once the blowout preventer or other valves at the surface are reopened the fallen items or cable must be retrieved before the well can be brought under production. Usually such fishing operations are both time-consuming and expensive.

### SUMMARY

In an embodiment of the present invention one or more geomagnetic sensors are placed adjacent to the well tubular throughbore on the surface and generally below the blowout preventer or other gate valves. The geomagnetic sensor takes an initial reading of the geomagnetic field in and around the well tubular throughbore. The initial reading is then digitally stored. The geomagnetic field changes as a metallic object is placed in or passes through the throughbore. A second reading is taken by the geomagnetic sensor and the now changed geomagnetic field due to the metallic object within the throughbore is compared to the initial geomagnetic field reading by a logic controller. When the second geomagnetic field reading is different from the initial geomagnetic field reading an indication is given that an object, whether another tubular or simply a cable, is within the throughbore and that the blowout preventer or other gate valves should not be closed except in an emergency. Further geomagnetic field readings are taken and compared by the logic controller to the initial reading, when a further reading is substantially similar to the initial reading the logic controller will provide an indication that the throughbore is clear.

Generally a geomagnetic sensor is a device for detecting and measuring magnetic fields. Many geomagnetic sensors operate by detecting effects of the Lorentz force. More specifically the geomagnetic sensor relies upon the Lorentz force acting on the current carrying conductor in the magnetic field. The mechanical motion of the microstructure may be sensed either electronically or optically.

In another embodiment of the invention a conductive coil is placed circumferentially around the blowout preventer or other tubular below any valve rams that may be present. The conductive coil then generates a magnetic field in and around the blowout preventor or other tubular. A magnetic sensor takes an initial reading of the magnetic field that is generated in and around the blowout preventor or other tubular. The initial reading is then digitally stored. The magnetic field changes as a metallic object is placed in or passes through the throughbore of the adjacent blowout preventor or other tubular. A second reading is taken by the magnetic sensor and the now changed magnetic field, due to the metallic object within the blowout preventor or other tubular, is compared to the initial magnetic field reading by a logic controller. When the second magnetic field reading differs from the initial magnetic field reading an indication is given that an object, whether another tubular or simply a cable, is within the blowout preventor or other tubular and that the blowout preventer or other gate valves should not be closed. As further magnetic field readings are taken and compared by the logic controller to the initial reading, when a further reading is substantially similar to the initial reading the logic controller will provide an indication that the throughbore is clear.

In a third embodiment of the present invention an ultrasound transmitter and receiver may be placed on the surface of the blowout preventer or tubular or in some cases a bore may be formed in the blowout preventer or tubular and an ultrasound transmitter and/or receiver may be placed within the bore. In any event the high-frequency sound waves generated by the ultrasound transmitter are directed radially inward towards the interior cavity within the blowout preventer or tubular. An ultrasound receiver, tuned for the ultrasound transmitter transmissions, receives the reflections of the ultrasound transmitter as the ultrasound transmissions are reflected by various objects within the blowout preventer or tubular. In some instances the metal-air interface, metal-liquid interface, or metal-metal interface will also reflect the ultrasound transmission back towards the ultrasound receiver. The ultrasound receiver, when initiated, takes an initial reading. Preferably the initial reading is conducted without a cable, tool, or second tubular within the bore of the blowout preventer or first tubular. The initial reading is then stored. At preset intervals the ultrasound transmitter and receiver operate to take subsequent readings which are then compared to the initial reading by a logic controller or processor. A change between the initial reading and a subsequent reading indicates that there may be a cable, tool, or second tubular within the bore of the blowout preventer or first tubular. The logic controller processor then displays an indication that there may be a cable, tool, or second tubular within the bore of the blowout preventer or first tubular. The display may be mechanical such as a raised flag, electric such as a light, or electronic such as on a display screen. Continuing at preset intervals the ultrasound transmitter-receiver op freight to take further readings which are then compared to the initial reading by the logic controller processor. Upon the further reading reverting to being substantially similar to the initial reading the logic controller then displays an indication that the bore of the blowout preventer a first tubular is clear. In each of the cases described above, whether for a geomagnetic sensor, a magnetic sensor, or an ultrasonic sensor, the logic controller may also send a signal to the controller of the blowout preventer or other gate valves restricting the closure of such valves when an object is within the bore of the blowout preventer or valves or releasing the restriction against closing when the bore of the blowout preventer or other valves is clear.

### BRIEF DESCRIPTION OF THE DRAWINGS

FIG. 1 is an orthographic depiction of a wellhead having a blowout preventor, gate valves, a lubricator, and a geomagnetic sensor.

FIG. 2 is a block diagram depicting the operation of the geomagnetic sensor, logic controller, memory, and display.

FIG. 3 is an orthographic depiction of a wellhead having a blowout preventor, gate valves, a lubricator, and a magnetic sensor.

FIG. 4 is a block diagram depicting the operation of the magnetic sensor, logic controller, memory, and display.

FIG. 5 is an orthographic depiction of a wellhead having a blowout preventor, gate valves, a lubricator, and two installations of ultrasonic transducers.

FIG. 6 is a block diagram depicting the operation of the ultrasonic transducers, logic controller, memory, and display.

### DETAILED DESCRIPTION

The description that follows includes exemplary apparatus, methods, techniques, or instruction sequences that embody techniques of the inventive subject matter. However, it is understood that the described embodiments may be practiced without these specific details. When referring to the top of the device or component top is towards the surface of the well. Side is radially offset from a component but minimally longitudinally offset.

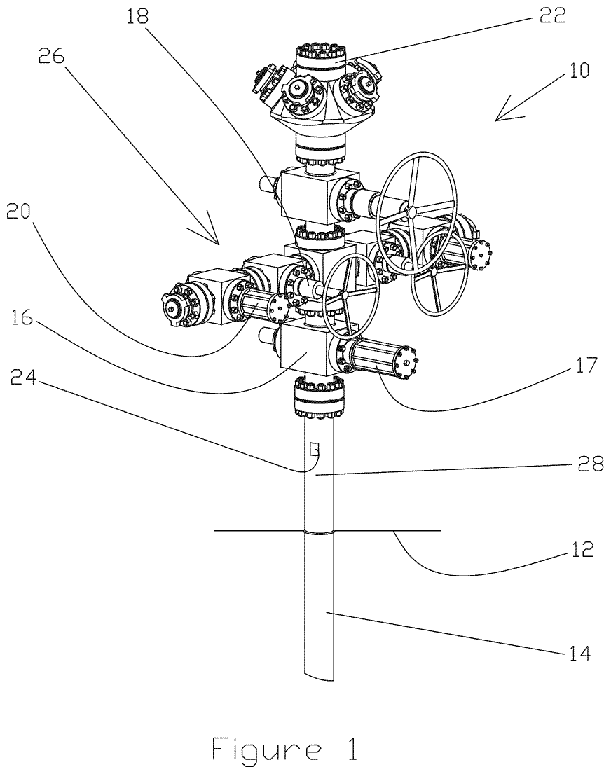

FIG. 1 is an orthographic depiction of a wellhead 10 having a blowout preventor 26, gate valves 16, and a lubricator 22. In this instance the blowout preventer 26 may be operated by manual controller 18 or the automatic controller 20. A gate valve 16 is shown with an automatic gate actuator 17. In this instance a geomagnetic sensor 24 is depicted attached to standpipe 28 which is a portion of the casing 14 that is above the surface 12, however the geomagnetic sensor 24 may be placed anywhere along the leading of the blowout preventer or other valves that may have a tubular or cable passing through them. The geomagnetic sensor detects and records a portion of the Earth's magnetic field that is local to the standpipe 28. The initial geomagnetic field recording is taken when the standpipe 28 does not have a tubular or cable located within the standpipe adjacent to the geomagnetic sensor 24. A steel tubular or cable placed within standpipe 28 changes the Earth's magnetic field that is local to the standpipe 28 adjacent to the geomagnetic sensor 24. At predetermined intervals the geomagnetic sensor takes secondary geomagnetic field readings. When the secondary reading differs from the initial reading the logic controller indicates that the standpipe 28 bore has an object within it. The geomagnetic sensor continues to take tertiary geomagnetic field readings and when the tertiary geomagnetic field reading reverts to or is similar to the initial reading the logic controller indicates that the standpipe 28 bore is clear.

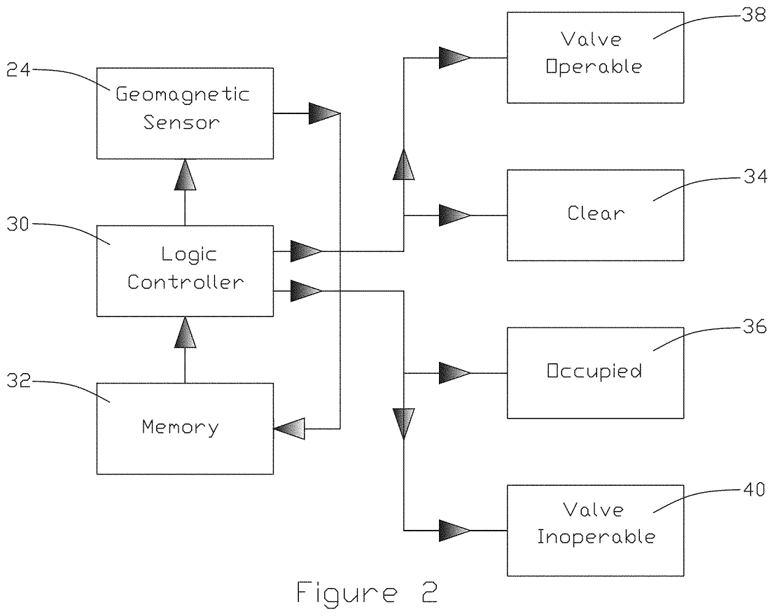

FIG. 2 is a block diagram depicting the operation of the geomagnetic sensor, logic controller, memory, and display. The geomagnetic sensor 24 may have a memory, a logic controller, and a display. When initiated the logic controller 30 sends a command to the geomagnetic sensor 24 to take an initial geomagnetic field reading. The geomagnetic sensor then takes the initial geomagnetic field reading and sends it to memory 32. The logic controller 30 will continue, at predetermined intervals, to command the geomagnetic sensor 24 to take secondary geomagnetic field readings and send each secondary geomagnetic field reading to memory 32. The logic controller 30 will then access from memory 32 the initial geomagnetic field reading and the secondary geomagnetic field reading. If the secondary geomagnetic field reading and the initial geomagnetic field reading are similar or within predetermined bounds then the logic controller will send a 1^{st} message 34 indicating that the standpipe 28 bore is clear. However, if the secondary geomagnetic field reading and the initial geomagnetic field readings differ or are outside of predetermined bounds then the logic controller 30 will send a 2^{nd} message 36 that the standpipe 28 bore is occupied. Additionally, in some instances the logic controller may also send a signal, such as valves operable 38, to any powered gate valve actuator, such as valve actuator 17 or blowout preventer valve actuator 20, that allows the gate valve to be closed when the bore is clear. Or the logic controller may send a signal, such as valves inoperable 40, to any powered gate valve actuator such as valve actuator 17 or blowout preventer valve actuator 20. In certain instances, the geomagnetic sensor, the logic controller, the memory, and the display may be a single unit in a single housing and the display may simply be a light on or off, a colored light, a raised flag, or other signal. In other instances, the geomagnetic sensor may be connected by wire or radio to a separate logic controller and memory such as an app on a smart phone, smart pad, or computer. The radio connection is a wireless connection that includes bluetooth, wi-fi, cellular or other radio types. The display may be directly wired to the logic controller or may be connected by radio to the logic controller and may simply be a screen where an icon or other notification may be displayed.

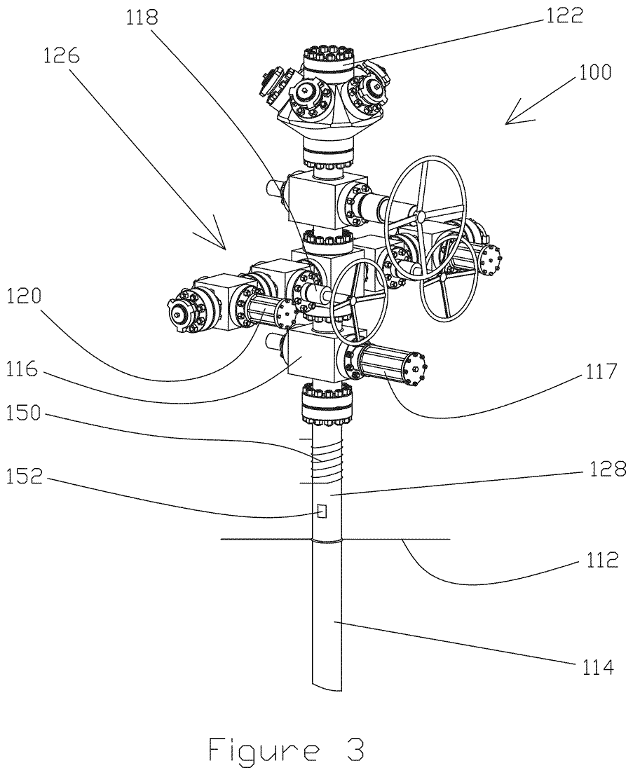

FIG. 3 is an orthographic depiction of a wellhead 100 having a blowout preventor 126, gate valves 116, and a lubricator 122. In this instance the blowout preventer 126 may be operated by manual controller 118 or the automatic controller 120. A gate valve 116 is shown with an automatic gate actuator 117. An induction coil 150 and magnetic sensor 152 are depicted attached to standpipe 128 which is a portion of the casing 114 that is above the surface 112. As before, the induction coil 150 and magnetic sensor 152 may be placed along the length of the bore of the standpipe, the blowout preventer 126, or gate valves 116. In certain instances a permanent magnet may be used in place of or in addition to the induction coil 150 to create a local magnetic field. The induction coil 150 generates a magnetic or electric field that is detectable by magnetic sensor 152. Magnetic sensor 152 detects and records at least a portion of the magnetic field that is local to the standpipe 128. The initial field recording is taken when the standpipe 128 does not have a tubular or cable located within the standpipe 128 adjacent to the magnetic sensor 124. A steel tubular or cable placed within standpipe 128 disturbs the local magnetic field near standpipe 128 and adjacent to the magnetic sensor 124. At predetermined time intervals the magnetic sensor 152 takes secondary geomagnetic field readings. When the secondary reading differs from the initial reading the logic controller indicates that the standpipe 28 bore has an object within it. The magnetic sensor continues to take tertiary magnetic field readings and when the tertiary magnetic field reading reverts to or is similar to the initial reading the logic controller indicates that the standpipe 128 bore is clear.

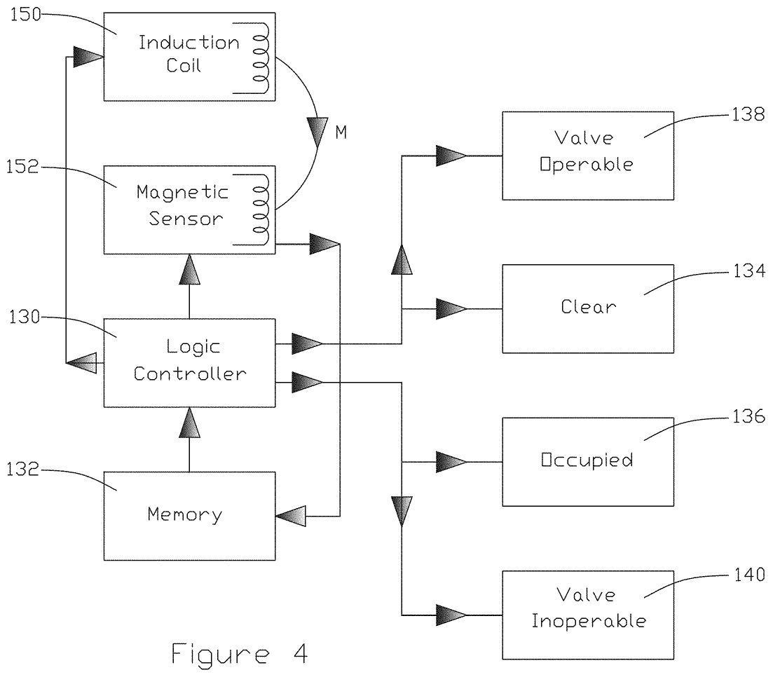

FIG. 4 is a block diagram depicting the operation of the induction coil, magnetic sensor, logic controller, memory, and display. The induction coil 150 may provide a continuous magnetic field, an intermittent magnetic field, or an on command magnetic field. The magnetic sensor 152 may include a memory 132, a logic controller 130, and a display. When initiated the logic controller 130 sends a command, if needed, to the induction coil 150 to create a magnetic field. The logic controller 130 also commands the magnetic sensor 152 to take an initial magnetic field reading. The magnetic sensor 152 takes the initial magnetic field reading and sends it to memory 132. The logic controller 130 will continue, at predetermined intervals, to command the induction coil 150 to create a magnetic field if necessary and also command the magnetic sensor 152 to take secondary magnetic field readings sending each secondary magnetic field reading to memory 132. The logic controller 130 will then access from memory 132 the initial magnetic field reading and the secondary magnetic field reading. If the secondary magnetic field reading and the initial magnetic field reading are similar or within predetermined bounds then the logic controller will send a 1^{st} message 134 indicating that the standpipe 128 bore is clear. However, if the secondary magnetic field reading and the initial magnetic field readings differ or are outside of predetermined bounds then the logic controller 130 will send a 2^{nd} message 136 that the standpipe 128 bore is occupied. Additionally, in some instances the logic controller 130 may also send a signal, such as valves operable 138, to any powered gate valve actuator, such as valve actuator 117 or blowout preventer valve actuator 120, that allows the gate valve to be closed when the bore is clear. Or the logic controller 130 may send a signal, such as valves inoperable 140, to any powered gate valve actuator such as valve actuator 117 or blowout preventer valve actuator 120. In certain instances, the magnetic sensor 152, the logic controller 130, the memory 132, and the display may be a single unit. The display may simply be a light on or off, a colored light, a raised flag, or other signal. In other instances, the geomagnetic sensor may be connected by wire or wireless to a separate logic controller and memory such as an app on a smart phone, smart pad, or computer. The display may simply be a screen where an icon or other notification may be displayed.

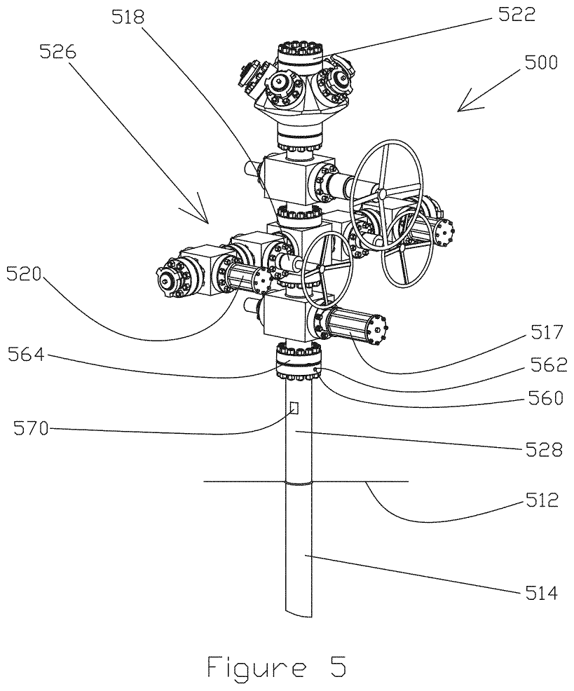

FIG. 5 is an orthographic depiction of a wellhead 500 having a blowout preventor 526, gate valves 516, and a lubricator 522. In this instance the blowout preventer 526 may be operated by manual controller 518 or the automatic controller 520. A gate valve 516 is shown with an automatic gate actuator 517. FIG. 5 depicts two types of ultrasonic transducer installations on a single wellhead 500. A first ultrasonic transducer 560 is located in a bore 562 in flange 564. A second ultrasonic transducer 570 is located on standpipe 528. However, both the 1^{st} ultrasonic transducer 560 and the 2^{nd} ultrasonic transducer 570 may be placed along the length of the bore of the standpipe 528, the blowout preventer 526, or and gate valves 516. Both ultrasonic transducers 570 and 560 emit an ultrasonic pulse radially inwards towards the standpipe 528 or wellhead 500 throughbore. The ultrasonic pulse (not shown) is then reflected back towards the emitting ultrasonic transducer 560 or 570 as a reflection (not shown). An initial ultrasonic pulse reading is recorded, usually, when the standpipe 528 does not have a tubular or cable located within the standpipe 528 adjacent to either 1^{st} ultrasonic transducer 560 or the 2^{nd} ultrasonic transducer 570. A steel tubular or cable placed within standpipe 528 or the wellhead 500 throughbore will reflect a portion of the ultrasonic pulse back towards the ultrasonic transducer where the presence of a reflected signal other than the throughbore wall indicates the presence of an object within the throughbore. At predetermined time intervals the ultrasonic transducers 560 and/or 570 takes secondary ultrasonic pulse readings. When the secondary reading differs from the initial reading the logic controller indicates that the standpipe 528 throughbore has an object within it. The ultrasonic transducers 560 or 570 continue to take tertiary ultrasonic pulse readings and when the tertiary magnetic field reading reverts to or is similar to the initial reading the logic controller indicates that the standpipe 528 bore is clear.

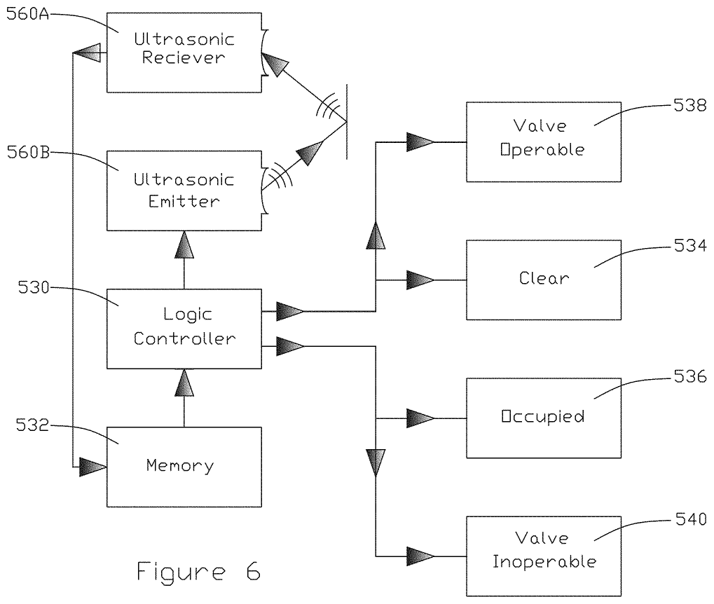

FIG. 6 is a block diagram depicting the operation of either ultrasonic transducer 560 or 570, a logic controller 530, a memory 532, and a display. The ultrasonic transducers 560 or 570 generally have an ultrasonic emitter 560B and an ultrasonic receiver 560A in the same housing however in some instances the ultrasonic receiver 560A may be in a different housing than the ultrasonic emitter 560B. In some instances the entire each sensor or unit including memory, logic controller, and display may be housed in the same unit. In any event, upon initiation or start the logic controller 530 sends a command, if needed, to the ultrasonic emitter 560B to send an initial ultrasonic pulse. The ultrasonic receiver 560A receives the initial ultrasonic pulse reflection or reflections and sends them to memory 532 to be recorded. The logic controller 530 will continue, at predetermined intervals, to command the ultrasonic emitter 560B to send secondary ultrasonic pulses. The secondary reflections of the secondary ultrasonic pulses are then recorded by ultrasonic receiver 560A and sent to memory 532. The logic controller 530 will then access from memory 532 the initial ultrasonic pulse reflection and the secondary ultrasonic pulse reflection. If the secondary ultrasonic pulse reflection and the initial ultrasonic pulse reflection are similar or within predetermined bounds then the logic controller will send a 1^{st} message 534 indicating that the standpipe 528 bore is clear. However, if the secondary ultrasonic pulse reflection and the initial ultrasonic pulse reflection differ or are outside of predetermined bounds then the logic controller 530 will send a 2^{nd} message 536 that the standpipe 528 bore is occupied. Additionally, in some instances the logic controller 530 may also send a signal, such as valves operable 538, to any powered gate valve actuator, such as valve actuator 517 or blowout preventer valve actuator 520, that allows the gate valve to be closed when the bore is clear. Or the logic controller 530 may send a signal, such as valves inoperable 540, to any powered gate valve actuator such as valve actuator 517 or blowout preventer valve actuator 520. In certain instances, the magnetic sensor 552, the logic controller 530, the memory 532, and the display may be a single unit. The display may simply be a light on or off, a colored light, a raised flag, or other signal. In other instances, the ultrasonic transducer 560 or 570 may be connected by wire or wireless to a separate logic controller and memory such as an app on a smart phone, smart pad, or computer. The display may simply be a screen where an icon or other notification may be displayed.

In each of the aforementioned scenarios it is envisioned that an initial reading of the geomagnetic field, magnetic field, or the ultrasonic pulse are each taken when the throughbore of the standpipe and or the wellhead adjacent to each of the sensors is clear. In certain instances, the initial reading may be taken with the throughbore occupied with the second and tertiary readings compared to the occupied throughbore. The logic controller will then adjust the display accordingly to show an occupied throughbore when the throughbore is in fact occupied and to show a clear throughbore in the throughbore is clear. Additionally, while one or more of the sensors may be placed within a bore, the bore does not penetrate the pressure vessel formed by the casing, the standpipe, the wellhead, or any of the valves attached to the wellhead.

The nomenclature of leading, trailing, forward, rear, clockwise, counterclockwise, right hand, left hand, upwards, and downwards are meant only to help describe aspects of the tool that interact with other portions of the tool.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A wellhead sensing system comprising;
a tubular having a throughbore affixed to a well,
a geomagnetic sensor, a logic controller, and a memory;
wherein the logic controller commands the geomagnetic sensor to take a first
reading and the first reading is sent to the memory,
wherein the logic controller commands the geomagnetic sensor to take a second
reading and the second reading is sent to the memory,
further wherein the logic controller compares the first reading to the second reading.

2. The wellhead sensing system of claim 1 wherein, the geomagnetic sensor, the logic controller, and the memory are housed in a single housing.

3. The wellhead sensing system of claim 1 wherein, the geomagnetic sensor sends and receives information between the logic controller and memory by wires.

4. The wellhead sensing system of claim 1 wherein, the geomagnetic sensor sends and receives information between the logic controller and memory by radio.

5. The wellhead sensing system of claim 1 wherein, the logic controller is connected to a display.

6. The wellhead sensing system of claim 1 wherein, the logic controller is connected to a display via radio.

7. A wellhead sensing system comprising;
a tubular having a throughbore affixed to a well,
an induction coil, a magnetic sensor, a logic controller, and a memory;
wherein the logic controller commands the magnetic sensor to take a first reading and the first reading is sent to the memory,
wherein the logic controller commands the magnetic sensor to take a second reading and the second reading is sent to the memory,
further wherein the logic controller compares the first reading to the second reading.

8. The wellhead sensing system of claim 7 wherein, the induction coil, magnetic sensor, the logic controller, and the memory are housed in a single housing.

9. The wellhead sensing system of claim 7 wherein, the magnetic sensor sends and receives information between the logic controller and memory by wires.

10. The wellhead sensing system of claim 7 wherein, the magnetic sensor sends and receives information between the logic controller and memory by radio.

11. The wellhead sensing system of claim 7 wherein, the logic controller is connected to a display.

12. The wellhead sensing system of claim 7 wherein, the logic controller is connected to a display via radio.

13. (canceled)

14. (canceled)

15. (canceled)

16. (canceled)

17. (canceled)

18. (canceled)

19. (canceled)
